(19) United States
(12) Patent Application Publication
(10) Pub. No.: US 2003/0063871 A1
(43) Pub. Date: Apr. 3, 2003

(54) Light-emitting module

(76) Inventors: Hiroyuki Yabe, Kanagawa (JP); Takashi Kato, Kanagawa (JP); Jiro Shinkai, Kanagawa (JP); Toshiro Takagi, Kanagawa (JP)

Correspondence Address: SMITH, GAMBRELL & RUSSELL, LLP, 1850 M STREET, N.W., SUITE 800, WASHINGTON, DC, 20036, US

(21) Appl. No.: 10/247,818

(22) Filed: Sep. 20, 2002

(30) Foreign Application Priority Data
Sep. 20, 2001 (JP) 2001-287772

(51) Int. Cl. G02B 6/42

(52) U.S. Cl. 385/88; 385/92

(57) ABSTRACT

Present invention relates to a light-emitting module used in the WDM optical source. The module comprises a semiconductor light-emitting device, an Ethalon, a plurality of optical detectors, and a switching element for selecting one of detectors. The detectors monitor light transmitted through individual potions where the transmittance of the Ethalon has a peculiar periodic behavior with almost same period, and generate outputs reflecting the periodic behavior. By selecting one of outputs from detectors by switching element and by feeding it back to temperature of the light-emitting device, the oscillation wavelength locks to the value of the WDM standard. In the present module, it is not necessary to use a thicker Ethalon to obtain the wavelength interval of the WDM standard.

### CROSS REFERENCE RELATED APPLICATIONS

This application contains subject matter that is related to the subject matter of the following application, which is assigned to the same assignee as this application and filed on the same day as this application. The below listed application is hereby incorporated herein by reference in its entirely:

“Optical Module” by Shinkai et al.

“Optical Module” by Takagi et al.

### BACKGROUND OF THE INVENTION

1. Field of the Invention

This invention relates to a light-emitting module, especially the module applied in the WDM (Wavelength Division Multiplexing) transmission system.

2. Related Prior Art

In the WDM system, the wavelength interval between respective channels is set to be 0.8 nm. This means that an absolute accuracy of the wavelength must be controlled within ±0.1 nm. Further, since a typical WDM system has 8-channel or more, all channels must satisfy such critical accuracy.

A method for locking an oscillation wavelength of a semiconductor laser and the light-emitting module has been disclosed in U.S. Pat. No. 5,825,792. In '792 patent, an Ethalon device with parallel optical surfaces is inclined to a divergent light beam from the laser and two photo diodes detect two beams respectively transmitted through different portions of the Ethalon. A differential signal of outputs from two diodes controls a temperature of the laser, thus locks the oscillation wavelength.

Another method using a wedge shaped Ethalon is also known. Although the view point that two photo diodes detect light beams respectively transmitted through different portion of the Ethalon is same as that disclosed in '792 patent, to slide the Ethalon normal to the optical axis enables to change an equivalent thickness of the Ethalon, by which transmitted beams are suffered. These prior methods are simple to lock the oscillation wavelength of the laser but hard to set the oscillation wavelength to the predetermined value required in the WDM system and quite hard to set the wavelength interval of respective channels to the WDM standard.

The transmittance of the Ethalon behaves a periodic characteristic with a period determined by the thickness of the Ethalon. When the period of the transmittance corresponds to the wavelength interval of channels in the WDM system, merely sliding the Ethalon normal to the optical beam can set the oscillation wavelength and automatically the wavelength interval of respective channels coincident with the WDM standard. However, such system that realizes the period of the transmittance of the Ethalon coincides with the WDM standard, requires a thicker Ethalon and narrows a capture range, within which the locking control of the oscillation wavelength is performed. Although the current WDM standard provides the wavelength interval of 0.8 nm as previously mentioned, a narrower interval is considered in the future system. In such standard, it would be quite hard to apply the conventional method using thicker Ethalon.

### SUMMARY OF THE INVENTION

The object of the present invention is to provide a new configuration of a light-emitting module that narrows the locking interval by using the conventional optical parts. To solve the subject, the module according to the invention may comprise a semiconductor light-emitting device, N count of optical detectors, an Ethalon and a means for selecting one of detectors. The Ethalon comprises N portions; each portion faces to the corresponding detector and has particular thickness that causes the specific transmittance with a period. The count of detector N is greater than or equal to 2.

It is preferable that the Ethalon is a wedge shaped Ethalon and detectors are monolithically integrated on a same body. This results in a compact sized module.

It is further preferable that the module contains a lens for converting divergent light from the light-emitting device into a collimated light. The Ethalon receives this collimated light. The collimated light to the Ethalon simplifies the relation of the transmittance to the thickness. Further, the positional interval of the i-th detector (2≦i≦N) to the nearest neighbor may be set to 1/N of the full period of the transmittance.

Another aspect of the invention, the module may further comprise an extra detector that monitors light not affected the periodic characteristic of the transmittance due to the thickness of the Ethalon. The extra detector may monitor light transmitted through the Ethalon over multiple integers of the period, or monitor light directly from the light-emitting device.

The module of the present invention may contain a thermoelectric cooler for adjusting the temperature of the light-emitting device. It is preferable that the module is applied in the WDM system with a wavelength controlling circuit that control the thermoelectric cooler based on the output of one detector selected from N detectors by the selecting means. Further, the module may contain another control circuit for maintaining the magnitude of the output light form the light-emitting device. The another control circuit receives a signal from the extra detector and feeds it back to a driving circuit of the light-emitting device.

The semiconductor light-emitting device is preferred to be a semiconductor laser and detectors including the extra detector are preferred to be photo diodes.

### BRIEF DESCRIPTION OF DRAWINGS

FIG. 1 is a view showing the present light-emitting module;

FIG. 2 is a cross-sectional view showing the primary assembly of the module;

FIG. 3 shows an Ethalon applicable to the present module;

FIG. 4(a) shows a block diagram of the wavelength locking circuit, FIG. 4(b) is a diagram showing the typical transmittance of the Ethalon, and FIG. 4(c) shows outputs of individual detector to the variation of the wavelength;

FIG. 5(a) shows a block diagram of the module using in the WDM system, and FIG. 5(b) shows outputs of each detector of the module;

FIG. 6 shows another example used in the WDM system, in which three detectors are contained;

FIG. 7 compares the present Ethalon and a hypothetical one with a thicker characteristic;

FIG. 8 shows a typical arrangement of detectors with the extra one for controlling the optical output power of the module;

FIG. 9 is an arrangement for controlling the optical output power of the module;

FIG. 10 shows another arrangement for controlling the output power of the module;

FIGS. 11(a) to 11(c) show another arrangement of the extra detector; and

FIG. 12 shows another arrangement of the present optical module.

### DETAILED DESCRIPTION OF THE INVENTION

The preferred embodiments of the optical module will be described in referring to drawings. In the description, elements identical to each other will be referred to with numerals identical to each other without their overlapping explanations.

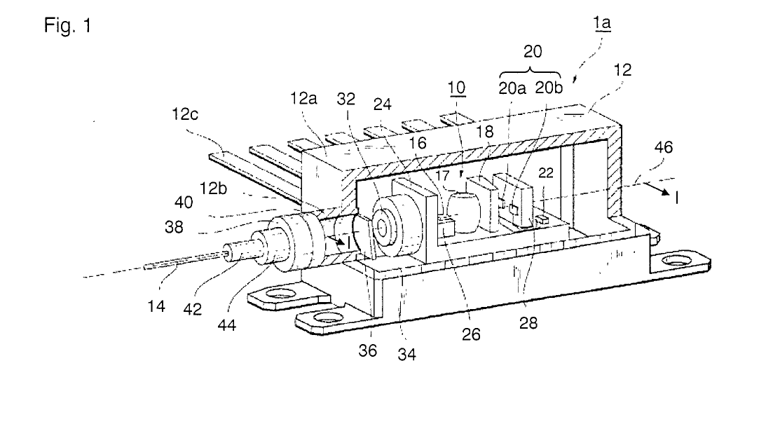

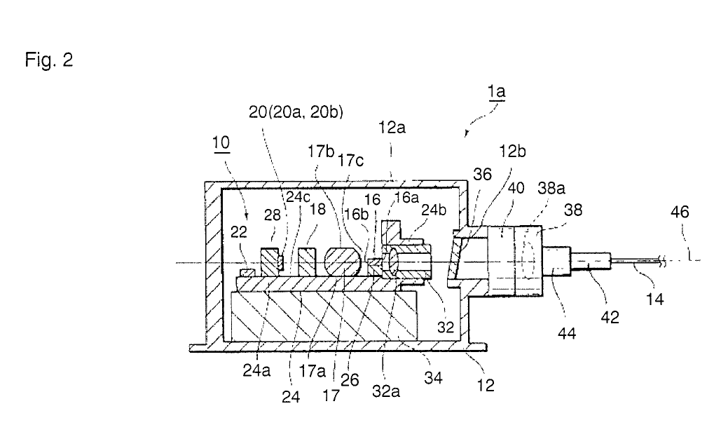

A semiconductor laser module 1a according to the present invention comprises a primary assembly 10 and housing 12. FIG. 1 is a view showing a semiconductor laser module 1a of the present invention and FIG. 2 is a cross sectional view of the module. The housing 12 forms a butterfly package. The package 12 arranges the primary assembly 10 therein and seals with an inert ambient, such as dry nitrogen. The housing 12 comprises a body 12a, a cylinder 12b, and a plurality of leads 12c. The primary assembly 10 has a semiconductor laser 16, a switching element 22, auxiliary members (24, 26, 28) and a lens holder 32. Although this embodiment locates the switching element within the housing, it may be applicable to place the switching element outside the housing. The auxiliary member 24 places members (26, 28), a lens 17, an Ethalon device 18, and some electronic circuit device 22 including the switching element, thereon. The auxiliary member 26 mounts the semiconductor laser 16. The member 24 is mounted on a thermoelectric cooler 34, such as a Peltier element. The thermoelectric cooler controls a temperature of the laser 16 thorough auxiliary members (24, 26). It is preferable for members to be made of material with good thermal conductivity. Aluminum Nitride (AlN) is one of the materials for the auxiliary members.

An opening for coupling the primary assembly 10 to the cylinder 12b is provided on one wall of the housing 12. A window 36 made of a hermetic glass seals the opening. Light emitted from the laser 16 passes through the opening and enters one tip of an optical fiber 14. Another lens holder 38 is provided at the edge of the cylinder 12b. An optical isolator 40 that cuts the light propagating from the optical fiber 14 to the laser 16 is placed between the lens holder 38 and the window 36.

The optical fiber 14 is inserted into the edge of the cylinder 12b. A ferrule 42 covers the tips of the fiber 14. The lens holder 38 holds a sleeve 44. Inserting the ferrule 42 into the sleeve 44, the optical position of the ferrule to the housing 12 is defined. Thus, the fiber 14, the lens holder 38 and the primary assembly 10 are optically aligned to each other.

Referring to FIG. 2, the auxiliary member 24 comprises a device-mounting portion 24a and a lens-supporting portion 24b. The lens-supporting portion 24b provides an opening to secure the lens holder 32 for holding a lens 32a. The lens collimates the light emitted from the laser 16. To slide the position of the lens holder 32 in the opening enables to adjust an interval between the laser 16 and the lens 32a.

The laser 16 comprises a first facet 16a, a second facet 16b, and an active layer (a light-emitting layer) provided between the first and the second facet. The laser 16 is placed on the auxiliary member 26. A pair of facet 16a and 16b of the laser forms an optical cavity. Since the reflectivity of the first facet 16a is lower than that of the second facet 16b, it enables to take out the light through the first facet 16a. The first facet 16a couples to the optical fiber 14 through two lenses (32a, 38a). It is preferable to use the DFB (Distributed Feedback Laser) laser 16. However, a Fabry-Perott type laser is also applicable. On the first facet 16a of the laser provides an anti-reflection coating, while a high-reflection coating is preferred to be on the second facet 16b of the laser. A SiN (Silicon Nitride) and amorphous a-Si are typically used as the coating material.

The primary portion 10 places the laser 16, the lens 17, the Ethalon 18 and the monitoring-device 20 on the device-mounting portion 24a in this order to enable the optical coupling between respective elements. The lens 17 comprises a flat surface opposing to the member 24 and a side surface 17b, the shapes of which is a spherical to collimate light. In this embodiment, the head of the lens 17 is cut to the flat surface 17c to eliminate the reflected light from entering back to the laser 16. The lens 17 is directly mounted on the auxiliary member 24 without a lens holder because of the flat surface 17c. Further, the cut of the head of the lens 17 enables the small sized package.

An Ethalon device 18 is placed on the auxiliary member 24. One surface 18a of the Ethalon is optically coupled to the facet 16b of the laser, while the other surface 18b of the Ethalon is coupled to the monitoring-device 20, which contains a first light detector 20a and a second light detector 20b therein.

The switching element connects respective detectors (20a, 20b) to a lead 12c, which transmits one of outputs from the first detector or the second detector to the leads 12c.

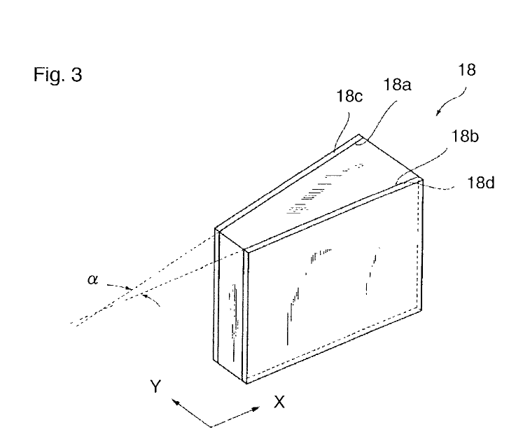

FIG. 3 shows the configuration of the Ethalon. The Ethalon has a pair of surface (18a, 18b), each make a slight angle α. The magnitude of the angle α is determined by the condition that light entering to the surface 18a may interfere with light reflected at the other surface 18b. It is preferable for the angle α greater than 0.01° and smaller than 0.1°. Ethalon shown in FIG. 3 is wedge type Ethalon and has reflection films 18c and 18d with multi-layered structure on surfaces 18a and 18b, respectively.

(First Embodiment)

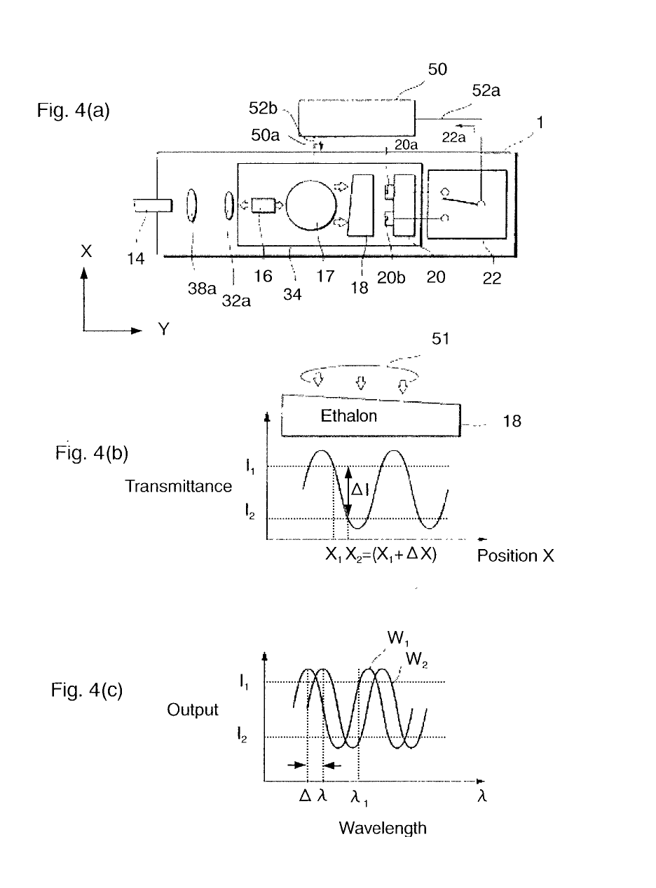

FIG. 4 shows the laser module 1 and a circuit block 50 for locking the wavelength. Detectors (20a, 20b) locate X₁ and X₂ (=X₁+ΔX), respectively. The circuit block 50 receives one of outputs from detectors (20a, 20b) selected by the switching element 22. The block generates an output 50a for adjusting the temperature of the laser 16. The thermoelectric cooler 34 receives the output signal 50a from the block 50, and controls the temperature of the laser 16. When the oscillation wavelength slightly shifts from the locked wavelength λ_{LOCK} thus determined, the output from detectors (20a, 20b) vary accordingly. The circuit 50 receiving the output from one of detectors drives the thermoelectric cooler so as to compensate the wavelength shift.

FIG. 4(b) shows a transmittance of the Ethalon for the wavelength λ emitted from the laser 16 held at the temperature T1. This diagram shows some periodic behavior with a period. The magnitude for the first detector 20a is I₁, while it is I₂ (=I₁−ΔI) for the second detector 20b, the location of which is shifted.

FIG. 4(c) is a diagram of respective outputs of detectors in the case that the wavelength entering to the Ethalon is changed. This figure also shows some periodicity with a period depending on the wavelength. As mentioned previously, detectors locate at X₁ and X₂, respectively. In FIG. 4(c), W₁ corresponds to the output from the first detector 20a, and W₂ corresponds to the second detector 20b. The difference between W₁ and W₂ is depicted by the phase difference Δλ. In the case that the light sensitivity of the first detector is substantially same with that of the second detector, the behavior W₁ for the first detector is equal to W₂ except their phase difference. From FIGS. 4(b) and 4(c), the thickness of the Ethalon and the wavelength of light entering to the Ethalon determine the period of W₁ and W₂, while the position of detectors determines the phase of W₁ and W₂.

The wavelength range where the oscillation wavelength is locked can be expanded by the switching element. The locking of the oscillation wavelength is not performed at regions around a relative maximum or relative minimum because the magnitude of the output is almost unchanged for the wavelength shift. However, even in the case that the behavior W₁ is in the relative maximum or minimum, it can be controlled by behavior W₂ for the second detector 20b.

(Second Embodiment)

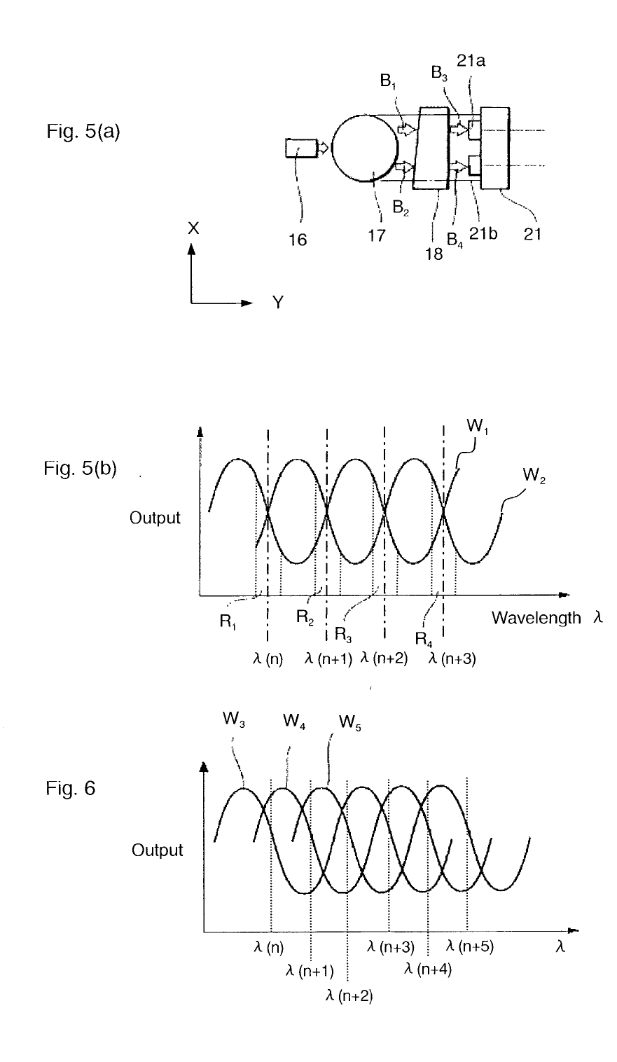

FIG. 5 shows an especial example of the first embodiment adequate for the WDM system. In this example, a first locking wavelength λ₁ determined by the periodicity of the transmittance of the Ethalon and the next nearest locking wavelength λ₂ have the particular relation. Namely, the interval of the locking wavelength is given by, (the period of the transmittance of the Ethalon at the position X)/(n+1); where n is an integer.

In FIG. 5(b), W₁ shows the output of the first detector 20a. The first detector can lock the oscillation wavelength in ranges R₁, R₃, . . . to respective wavelength λ(n), λ(n+2), . . . by the previously explained means through the circuit block 50. Although the output of the first detector 20a varies for the wavelength shift in ranges R₂, R₄, . . . , the detector 20a can not lock the wavelength to λ(n+1), λ(n+3), . . . , because the relation of the changes to the wavelength shift is opposite to that in R₁ and R₃. On the other hand, W₂ corresponds to the output from the second detector 20b. The detector 20b can lock the oscillation wavelength in ranges R2, R4, . . . to λ(n+1), λ(n+3), respectively. Merely turning the switching means 22 selects either the behavior W₁ or the behavior W₂, which corresponds to the locking wavelength. Therefore, in the present invention, the locking wavelength λ(n), λ(n+1), λ(n+2), λ (n+3), . . . are selected by the switching means 22.

Behavior W₁ and W₂ are obtained by the output from substantially same detectors except respective positions against the Ethalon. By arranging two detectors apart from each other by πin the periodicity of the transmittance of the Ethalon enables the interval of the locking wavelength to be 2π/2=π in the periodicity of the transmittance of the Ethalon.

(Third Embodiment)

FIG. 6 shows another example of the present optical module for the light source of the WDM transmission system. This module has three optical detectors that have a substantially same optical sensitivity. The positional interval between the first detector and the second detector is apart 2π/3 in the behavior of the transmittance of the Ethalon, and the interval between the second and the third detector is also apart by 2π/3 in the periodicity of the transmittance of the Ethalon to the position X.

In FIG. 6, the phase for behaviors (W₃, W₄ and W₅) is shift by one third of the nearest interval between the relative maximum in the periodicity of the transmittance of the Ethalon. The behavior W₃ defines the locking wavelength λ(n) and λ(n+3), W₄ defines λ(n+1) and λ(n+4), and W5 defines λ(n+2) and λ(n+5). By selecting one of behavior with switching means enables to lock the oscillation wavelength by the step of one third of the period of the transmittance of the Ethalon.

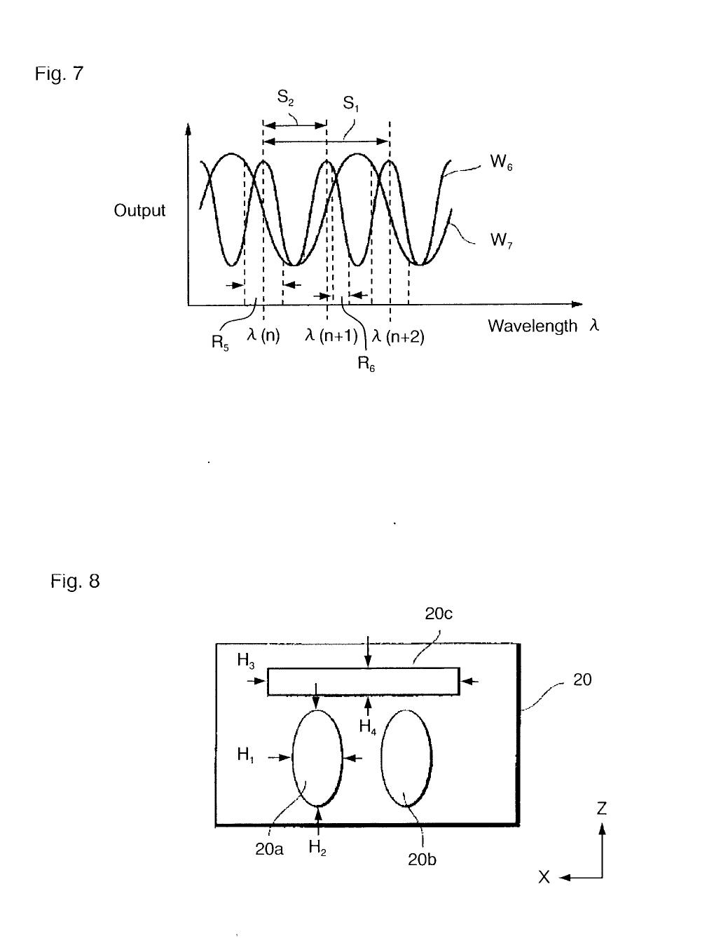

FIG. 7 shows two behaviors W₆ and W₇, the former corresponds to the Ethalon 18 shown in FIG. 3 and the latter reflects another type, the period of which is a half of the former. Since the period of the transmittance of the Ethalon relates to n·d/λ, where n is a refractive index of the Ethalon, the half period means that the thickness is twice. FIG. 7 also shows capture ranges R₅ and R₆ for each Ethalon, within which the oscillation wavelength can be locked to the center wavelength λ(n), λ(n+1), . . . for each behaviors and it is roughly equal to a half of the period. The range R₅ is wider than R₆. Although using a thicker Ethalon narrows the interval of the locking wavelength, the control of the locking becomes hard because of the narrowing of the capture range. To use the switching element 22 in the present invention, it is realized to narrow the interval of the locking wavelength necessary for the WDM transmission system with keeping the capture range as wide as before.

(Fourth Embodiment)

Next is another module with a function not only to lock the wavelength but also to maintain the magnitude of the optical output of the module.

FIG. 8 shows a configuration of an optical detector using in the present embodiment. The monitoring device 20 has a first detector 20a, a second detector 20b, and a third detector 20c. Detectors 20a and 20b control the locking wavelength as previous embodiments. They have a width H₁ along X-direction parallel to the inclined direction of the Ethalon 18, and a height H₂ along Z-direction. The height H₂ is greater than the width H₁, which is preferable for the wavelength locking because of the improved sensitivity for the wavelength fluctuation. The third detector 20c is for monitoring the output power of the laser 16. The configuration of this detector 20c has expanded width H₃ and shrunk height H₄ along Z-direction, which compensates the periodicity of the transmittance of the Ethalon, namely the detector 20c detects light transmitted from various portion of the Ethalon, thus compensates the dependence on the thickness.

(Fifth Embodiment)

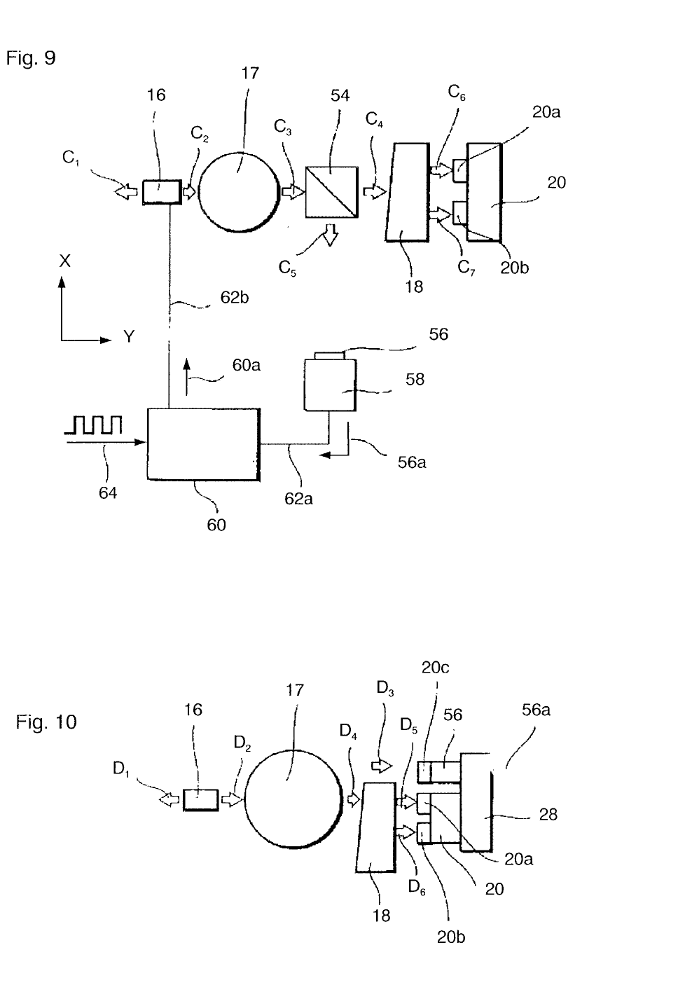

FIG. 9 shows another embodiment of the module. This embodiment contains an optical splitter 54 between the lens 17 and the Ethalon 18 and another light monitoring-device 56 placed on an auxiliary member 58. Beam C₁ is emitted from the front facet of the laser, while Beam C₂ is from the other facet of the laser and enters the lens 17. The lens converts beam C₂, which is divergent, into a collimated beam C₃. Beam C₃ is split into two beams C₄ and C₅. Beam C₄ enters the Ethalon and generates two transmitted beams C₆ and C₇. C₆ enters the first detector 20a and C₇ enters the second detector 20b. On the other hand, C₅ enters the third detector 56. The APC (Auto Power Control) circuit 60 adds the output of the detector 56 to an input signal 64 and conducts thus superimposed signal to the laser 16. The same configuration with this embodiment is also applicable to the former embodiment, in which the output of the third detector 20c may be coupled to the APC circuit.

(Sixth Embodiment)

FIG. 10 shows the sixth embodiment of the invention. This embodiment arranges the additional detector 56 on the auxiliary member 28. The detector 56 monitors light directly from the lens 17 and not through the Ethalon. The optical beam D₂ emitted from one facet of the laser 16 enters the lens 17. The lens 17 converts divergent beam D₂ to collimated beams D₃ and D₄. The Ethalon 18, receiving the beam D₄, generates beams D₅ and D₆, both reflects the dependence on the thickness of the Ethalon. The collimated light beam D₃ directly enters the detector 56 and controls the magnitude of the optical output of the module through the APC circuit, which is not shown in FIG. 10.

(Seventh Embodiment)

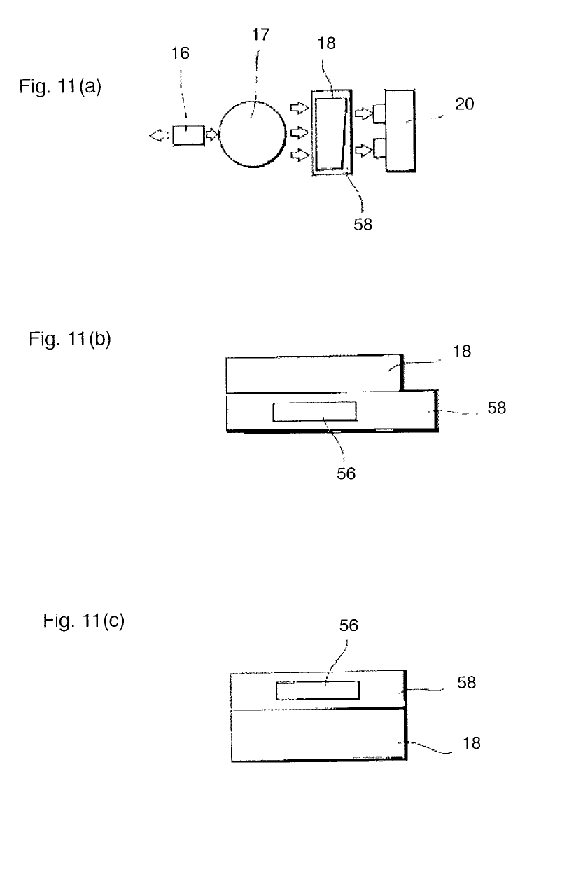

FIG. 11 shows the seventh embodiment of the invention. In this embodiment, the Ethalon is arranged on top of the auxiliary member 58, the side wall of which the another detector 56 for controlling the output power of the module is attached thereto (FIG. 11(b)), or the detector 56 for controlling the output power of the module is placed on top of the Ethalon (FIG. 11(c)). Both arrangements enable that the another detector can directly monitor light emitted from the lens 17 not through the Ethalon 18. Therefore, the output of the detector 56 only reflects the magnitude of the output light not depending on the thickness of the Ethalon, and enables to maintain the magnitude of light.

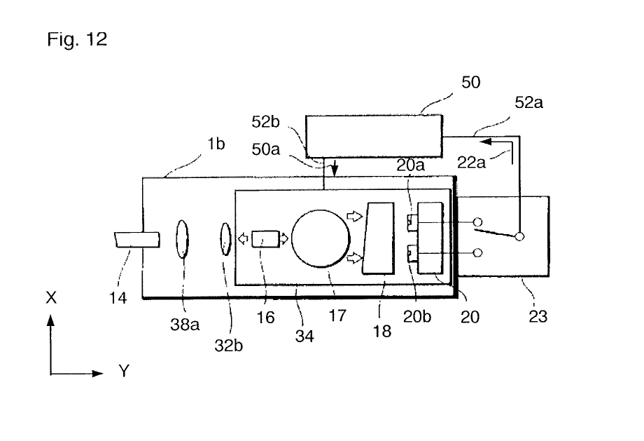

FIG. 12 shows the case that the switching means 23 is not placed within the housing. The switching means 23 and the circuit block 50 for receiving the signal 22a selected by the switching means 23 and driving the thermoelectric cooler in the housing, are placed out of the housing. According to this configuration, further complicated function requiring large-scale circuits may be realized.

From the invention thus described, it will be obvious that the invention may be varied in many ways. Various types of arrangements of detectors are described; other combinations are considered to be within the scope of the present invention. Further, the light-monitoring device may integrally contain two detectors or more, or may be discrete device independently to each other. Such variations are not to be regarded as a departure from the spirit and scope of the invention, and all such modifications as would be obvious to one skilled in the art are intended for inclusion within the scope of the following claims.

We claim:

1. An light-emitting module, comprising:
a semiconductor light-emitting device;
N count of optical detectors for generating output, said detectors optically coupling to said semiconductor device;
an Ethalon device having N count of portions along a first direction, each of said portions containing an optical axis coupling said semiconductor device to one of said optical detectors, each of said portions having a thickness and a transmittance with a period determined by said thickness; and
a switching means for selecting one of said output of said detectors, wherein N is greater than or equal to 2.

2. The light-emitting module according to the claim 1, wherein said Ethalon device is a wedge shaped Ethalon.

3. The light-emitting module according to the claim 1, wherein said optical detectors is monolithically integrated.

4. The light-emitting module according to the claim 1, wherein a width of said detectors parallel to said first direction is smaller than a length parallel to second direction normal to said first direction.

5. The light-emitting module according to the claim 1, further comprising a lens provided between said semiconductor device and said Ethalon device.

6. The light-emitting module according to the claim 1, wherein an interval of i-th (2≦i≦N) detector to the neighbor detector is substantially equal to 1/N of said period of said transmittance of said Ethalon.

7. The light-emitting module according to the claim 1, further comprising an extra detector for monitoring light not reflecting said period of said transmittance of said Ethalon.

8. The light-emitting module according to the claim 7, wherein said extra detector monitors light transmitted through said Ethalon over multiple integers of said period.

9. The light-emitting module according to the claim 7, wherein said extra detector locates on said Ethalon.

10. The light-emitting module according to the claim 7, wherein said Ethalon locates on said extra detector.

11. The light-emitting module according to the claim 7, further comprising a beam splitter provided between said lens and said Ethalon for splitting light emitted from said lens into two light beams, said Ethalon receiving one of said split beam,
wherein said extra detector monitors light split by said beam splitter.

12. The light-emitting module according to the claim 1, wherein said semiconductor light-emitting device is a semiconductor laser.

13. The light-emitting module according to the claim 1, wherein said detectors are photo diodes.

14. An optical source for a specific channel of a wavelength division multiplexing system, said optical source comprising:
a semiconductor laser for emitting light of a predetermined magnitude at a temperature;
N count of photodiodes for generating an output, said photodiodes optically coupling to said semiconductor device;
a wedge shaped Ethalon device having N portions along a first direction parallel to an inclined direction of surfaces of said Ethalon device, each of said N portions facing to one of said photodiodes and having a transmittance with a period determined by said thickness of said portions;
a lens provided between said semiconductor device and said Ethalon device for collimating said light emitted from said semiconductor device;
a switching means for selecting one of said output of said photodiodes;
a thermoelectric cooler for varying said temperature of said laser; and
a first control means for controlling said thermoelectric cooler based on said output selected by said switching means,
wherein N is greater than or equal to 2.

15. The optical source according to the claim 12, further comprising a housing for securing said laser, said lens, said Ethalon, said photodiodes, and said thermoelectric cooler.

16. The optical source according to the claim 13, wherein said housing further secures said switching means.

17. The optical source according to the claim 12, wherein an interval of i-th (2≦i≦N) photodiodes to the neighbor photodiode is substantially equal to 1/N of said period of said transmittance of said Ethalon.

18. The optical source according to the claim 12, further comprising an extra photodiode for monitoring said light emitted from said laser not through said Ethalon and generating an extra output, and a second control means for controlling a said magnitude of said laser based on said extra output.
